(19) United States
(12) Patent Application Publication
(10) Pub. No.: US 2016/0323107 A1
(43) Pub. Date: Nov. 3, 2016

(54) Secure Optical Codes for Accessing Content

(71) Applicant: International Business Machines Corporation, Armonk, NY (US)

(72) Inventors: Kulvir S. Bhogal, Fort Worth, TX (US); Jonathan F. Brunn, Logan, UT (US); Jeffrey R. Hoy, Southern Pines, NC (US); Asima Silva, Holden, MA (US)

(21) Appl. No.: 14/699,680

(22) Filed: Apr. 29, 2015

(51) Int. Cl. H04L 9/32

(52) U.S. Cl. CPC H04L 9/3247

(57) ABSTRACT

Mechanisms for generating a secure optical code having a reference to a resource encoded therein are provided. The mechanisms receive the reference to the resource for which a secure optical code is to be generated and generate a digital signature for the reference. The reference is modified to include the digital signature and thereby generate a modified reference. A secure optical code is generated based on the modified reference. The secure optical code encodes both the reference to the resource and the digital signature. The secure optical code is output for implementation in a print or visual output. The secure optical code is a pattern of shapes, having at least one of different positions or visual characteristics, which together represent the modified reference.

### BACKGROUND

The present application relates generally to an improved data processing apparatus and method and more specifically to mechanisms for providing secure optical codes for accessing content.

Various two dimensional optical codes for identifying resources are available which may be scanned by optical reader devices to identify the resource locators, addresses, or other references to the resources for purposes of retrieving the resources for use on a computing device. For example, bar codes, Quick Response (QR) codes, and Microsoft Tags are examples of such two dimensional optical codes that may be scanned by an image capture device and converted to an address or reference to a resource or digital content either present on the computing device associated with the image capture device or accessed from a remote computing device via a data network. QR codes, for example, consist of black modules (square dots) arranged in a square grid on a white background, which can be read by an image capture device and processed using Reed-Solomon error correction until the image can be appropriately interpreted. The required data is then extracted from the patterns present in both horizontal and vertical components of the image. Microsoft Tags provide similar capabilities with triangular patterns. Bar codes utilize a series of bars of various length and thicknesses to encode information.

The use of such optical codes is prevalent within today's society. Many advertisements, books, video games, magazines, and the like, utilize such codes to link the content associated with the optical code to resources and content available via remote data processing systems. For example, advertising utilizes such optical codes to link the advertisement to a product or service provider's website and/or additional content available via the website.

### SUMMARY

In one illustrative embodiment, a method, in a data processing system comprising a processor and a memory, for generating a secure optical code having a reference to a resource encoded therein, is provided. The method comprises receiving, by the data processing system, the reference to the resource for which a secure optical code is to be generated. The method also comprises generating, by the data processing system, a digital signature for the reference and modifying, by the data processing system, the reference to the resource to include the digital signature and thereby generate a modified reference. Moreover, the method comprises generating, by the data processing system, a secure optical code based on the modified reference. The secure optical code encodes both the reference to the resource and the digital signature. Furthermore, the method comprises outputting, by the data processing system, the secure optical code for implementation in a print or visual output. The secure optical code is a pattern of shapes, having at least one of different positions or visual characteristics, which together represent the modified reference.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIGS. 3A and 3B illustrate examples of valid and malicious optical codes illustrating an inability for human recognition of malicious optical code;

FIG. 4 is a diagram illustrating various stages of secure optical code generation and utilization in accordance with one illustrative embodiment;

FIG. 5 is a flowchart outlining an example operation for generating a secure optical code in accordance with one illustrative embodiment; and

FIG. 6 is a flowchart outlining an example operation for processing a secure optical code in accordance with one illustrative embodiment.

### DETAILED DESCRIPTION

Optical codes, i.e. visual representations of information as patterns of a plurality of shapes having different shades, colors, positions, or other visual characteristics, such as QR codes, matrix/2D barcodes, Microsoft Tags, and the like, are highly vulnerable to tampering in general. This is primarily because a malicious optical code looks very similar to a valid optical code to the human eye due to the optical codes being patterns of dark and light shapes that are not readily discernable as indicative of specific information to the human viewer, i.e. the optical codes simply look like a collection of dots, rectangles, triangles, bars, or the like. Thus, attackers who tamper with such optical codes are able to inject or overlay malicious links or references to malicious resource or content and such injection goes undetected for potentially long periods of time.

Such malicious attacks may occur in the most innocuous places. For example, a map at a bus stop may have an associated QR code (or any type of optical code) for linking to bus schedule information online and an attacker can print a QR code sticker that is overlaid on the original QR code to redirect users to install a malicious application when the malicious QR code is scanned by the image capture device. Similarly, a banner at a bank may highlight a new banking application with a QR code link which may be modified by an attacker at a banner printing company altering the digital ink image such that it links to a malicious banking site for collecting passwords. As another example, a computerized advertisement display may cycle product displays with corresponding QR code links for obtaining more information. An attacker may be able to hijack the display server to swap in QR codes linking to malicious content, such as a malicious application or the like.

In still other scenarios, a user may print a 2D bar code sticker from a shipping company and deposit a package at a package delivery store. A malicious user could then print an alternate bar code sticker and modify price, destination, or the like. In another scenario, a QR code generator may be co-opted and used to generate links to only malicious websites, or which generates occasional malicious QR codes linking to malicious websites that, because of the infrequency with which the malicious QR codes are generated, may be undetected when generating bulk QR codes, e.g., printing a large number of advertisements for distribution across a large geographic area. In yet another scenario, QR codes used for inventory purposes may be modified so as to facilitate theft from a retail establishment, e.g., a retail employee may steal an expensive item from the retail establishment by transferring the QR code of a less expensive item to the more expensive item.

Various other scenarios exist in which the intended optical code is modified to an optical code that redirects users scanning the optical code to a malicious website, malicious content, or otherwise causing the user's computing device to download and install malicious applications may occur as well. In general, each of these scenarios involve the original optical code being replaced with another optical code and because the codes are not readily human readable, differences between legitimate optical codes and malicious replacements are not recognized by the average human user of these optical codes. However, in addition to malicious intent, accidental misplacement of optical codes may also take place, such as a sticker with an optical code falling off of a shipping container and becoming affixed to a different shipping container, thereby leading to a shipping company scanning an incorrect sticker.

The illustrative embodiments provide mechanisms to prevent or at least minimize a user's exposure to malicious content when making use of an optical code to access content and/or identify accidental misplacement of optical codes. The illustrative embodiments provide mechanisms for authenticating the optical code as well as the source of the content to which the optical code directs the user's client device. Authentication of the optical code comprises embedding into the optical code a signature of the reference (e.g., a Uniform Resource Locator (URL), network address, or the like) to content (e.g., a web page, multi-media content, or the like) encoded by the optical code such that the signature can be used to authenticate the reference to content. In this way, the user's client device can be sure that the optical code itself has not been tampered with and comes from a source that provides reference authentication. The authentication of the source of the content can be performed by utilizing one or more reputation databases and services to check the reputation of the source of the reference to content or optical code's referenced domain to ensure that the source is a reputable or trustworthy source of content and not a potentially malicious or suspect source. Appropriate warnings may be output to the user in response to these authentications failing. Moreover, in some cases, access to potentially malicious content may be blocked entirely to prevent corruption of the client device.

In one illustrative embodiment, when an authentic provider of content wishes to generate an optical code, e.g., Quick Response (QR) code, bar code, Microsoft Tag, or the like, an optical code generator is employed and given an input of a reference to the content for which the optical code is to be generated. This may be given by manual entry by a user, navigating to the content and then requesting that the optical code generator generate a code for the current content, or any other manner of specifying to the generator the textual reference to the content that is to be used as a basis for generating the optical code. For purposes of the following description, a non-limiting example of a QR code being generated for a Uniform Resource Locator (URL) that references a portion of content, e.g., a webpage, online video or advertisement, multi-media content, or the like. However, it should be appreciated that this example is only for illustrative purposes and the optical code, reference, and actual content can take many different forms and any optical code, reference, and content is intended to be within the spirit and scope of the illustrative embodiments.

Given the URL for the content, for example, the optical code generator employs a security module to generate a signature for the URL to thereby sign the URL. For example, if the URL is for a target content “example.com/newproduct” (please note that full URLs are not utilized herein to avoid embedding hyperlinks into the present document) at the domain “example.com,” then a signature capability tied to the domain, such as a private Secure Socket Layer (SSL) certificate, a hash value of the URL generated using public-private key encryption, or other currently known or later developed security signature mechanism is used to generate the signature, e.g., a private key associated with the domain or source of the content is used to generate the signature which can be decrypted using the public key without exposing the private key. The URL is signed using the generated signature as a query parameter of the URL, e.g., example.com/newproduct?sig=048gN1D2SAfc7ksyRYCK.

The resulting signed URL is then used as a basis for generating an optical code, e.g., QR code, such that the signed URL, including the generated signature, is encoded by the QR code. Thus, the QR code includes information for verifying that the QR code has not been tampered with. That is, when decoded, if the embedded signature does not match with the URL signed by the signature, then the QR code will be determined to have been tampered with or modified in some way.

For example, when a user scans the QR code using their image capture device, e.g., camera enabled mobile phone, personal digital assistant, portable tablet computer, or other portable computing device, and uses a QR code application running on their portable computing device for interpreting the QR code, in accordance with the illustrative embodiments, the image capture device captures an image of the QR code and the QR code application decodes the QR code to extract the URL and the signature. The URL may then be used by the QR code application to access the linked website domain, e.g., “example.com”, to obtain the public key value associated with the website without having to access the resource itself and potentially expose the computing device to potentially malicious content. For example, a secure connection handshake operation, such as a Secure Socket Layer (SSL) handshake operation, can be performed to obtain the public key value, security certificate, or the like. The public key obtained from the website domain may then be used to decrypt the signature portion of the QR code and compare the decrypted signature with the URL to ensure that there is a match. Such public key/private key encryption/decryption mechanisms are generally known in the art and thus, a more detailed description of such is not provided herein.

If there is a match, then the QR code has not been tampered with. If there is a mismatch, then the QR code may have been tampered with and is not able to be relied upon as authentic. If there is a mismatch, appropriate error and warning outputs may be generated on the user's portable computing device to inform the user of the potential risk in using the QR code and/or blocking the user from utilizing the QR code to access the content associated with the URL. Thus, using the embedded signature of the URL in the QR code, the integrity of the QR code and the URL may be verified.

The above verification is used to verify the integrity of the QR code and the URL represented by the QR code. However, it is possible that a malicious source may have distributed its own signed QR codes, i.e. the malicious domain may generate its own URL and sign it with its own digital signature mechanisms such that the resulting QR code represents a signed URL that, when verified for integrity, will verify that the URL was signed by the malicious domain. As a result, the URL and QR code will be considered to be authentic with regard to the integrity of the URL and QR code but may still redirect the user's portable computing device to malicious content.

In order to avoid such situations, once the QR code and URL integrity are verified, the reputation of the source of the URL is verified to ensure that the QR code and URL did not originate from a malicious, disreputable, untrusted, or even unverifiable source. The domain or other source designation may be compared to a compiled database of domains/source designations that specifies reputable/disreputable (trustworthy/untrustworthy) domains or sources of content. For example, in one illustrative embodiment, the database may specify domains/sources which are known to be malicious or suspect and possibly harmful to the user's portable computing device. If the domain or other source designation associated with the QR code and URL is found in this database, then it may be determined that, while the integrity of the QR code and URL are intact, the QR code and URL direct the user's portable computing device to a potentially harmful content and thus, blocking of the access of this harmful content, or at least an output of a warning to the user is to be performed. Alternatively, the database may store information about validated or reputable domains or source designators and thus, if the domain or source designator associated with the QR code and URL is present within the database, it may be determined that the QR code and URL are reputable, whereas if it is not, then the domain or source designator may be considered questionable and an appropriate action of blocking or outputting a warning may be performed.

In some illustrative embodiments, in addition to, or in replacement of, the digital signature generated by the security mechanisms associated with the domain, the mechanisms of the illustrative embodiments may encode in the optical code, e.g., QR code, physical attributes of the objects to which the optical code is affixed. Similar to the signature, these physical characteristics of the object may also be added into the URL as query parameters, e.g., example.com/newproduct?weight=10kg&h=10in&w=5in&d=5in, where the dimensions of the package are weight of 10 kg, height of 10 inches, width of 5 inches, and depth of 5 inches. The result may be signed and the digital signature may be added to the URL as well as a query parameter, e.g., example.com/newproduct?weight=10kg&h=10in&w=5in&d=5in&sig=z1G4Qu13zEX FyPP0zE6FcuNh7Zvrz0AotkeC4E2Gi9daCanpSYNQy9J20J1G where the digital signature covers the entire URL including preceding query parameters. The addition of these characteristics and signature as query parameters provides backward compatibility such that applications that do not utilize the additional capabilities of the illustrative embodiments will process the QR codes in a manner generally known in the art.

When the QR code having the physical characteristics and digital signature encoded in it is scanned by an image capture device and QR application is used to interpret the QR code, the URL is again used to access the domain that is the source of the signature to obtain the public key information for decrypting the signature. The signature is then used to verify against both the URL and the physical characteristics captured within the URL. The physical characteristics of the object to which the QR code is affixed may further be validated by measuring the actual physical characteristics and comparing them to those that are specified in the URL which is represented by the QR code. If these characteristics match within a given tolerance, then the QR code is authenticated at least with regard to the physical characteristics. If these characteristics do not match within the given tolerance (used to accommodate acceptable differences is measuring equipment for example), if the signature does not match the URL or physical characteristics, or if the domain or source designation is determined to be not reputable as discussed above, then the accessing of the content associated with the QR code may be disabled or blocked, or an appropriate warning message may be output to the user.

Thus, the illustrative embodiments provide mechanisms for verifying the integrity of the optical code, verifying the correctness of the association of the optical code with a physical object, and verifying the reputation of the domain or source associated with the optical code. As a result, the mechanisms of the illustrative embodiments minimize the likelihood that a malicious entity is able to tamper with or replace a valid optical code with a malicious one. In addition, the mechanisms of the illustrative embodiments provide for the detection of misplaced optical codes.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

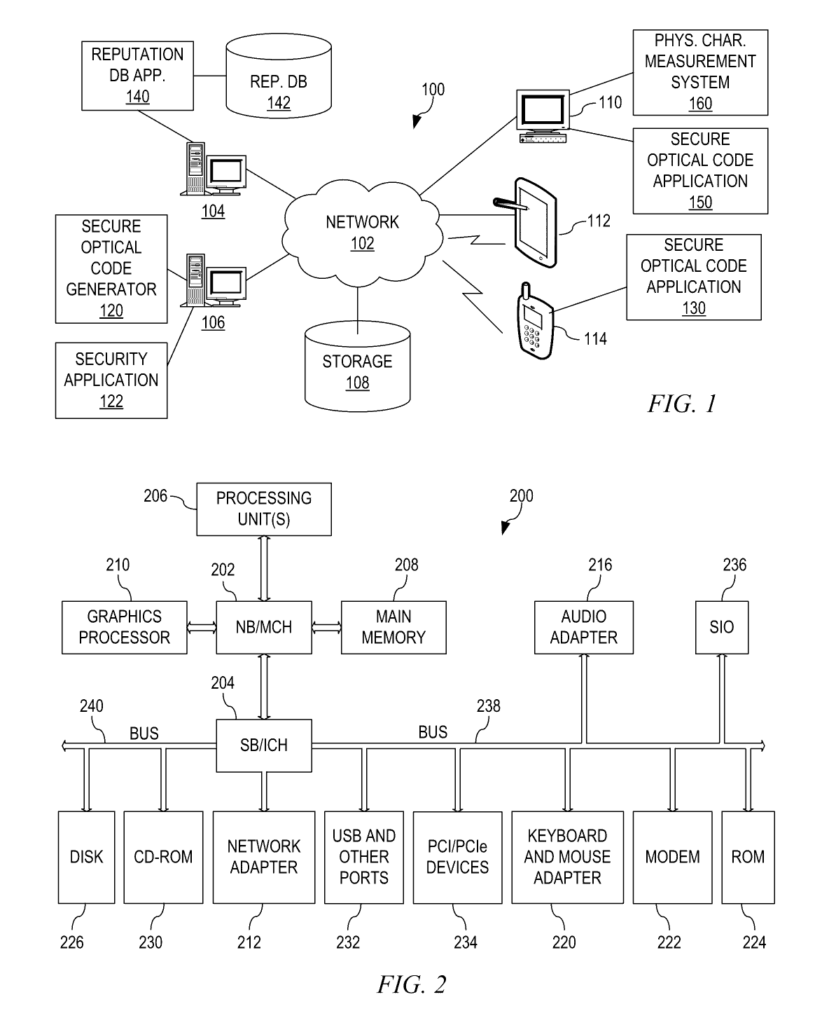

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, tablet computers, smart phones, or the like. In the depicted example, server 106 provides data, such as boot files, operating system images, and applications to the clients 110, 112, and 114. Clients 110, 112, and 114 are clients to server 106 in the depicted example. Distributed data processing system 100 may include additional servers, clients, and other devices not shown. In the depicted example, client 110 is a stationary computing device coupled to network 102 via a wired connection, client 112 is a tablet computer coupled to network 102 via one or more of a wired connection or wireless connection, and client 114 is a mobile smart phone coupled to network 102 via a wireless connection.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

In accordance with the mechanisms of the illustrative embodiments, one or more of the servers 104, 106 (in the depicted example server 106) comprises a secure optical code generate 120 in accordance with the mechanisms of the illustrative embodiments. The secure optical code generator 120 obtains or is provided with a reference, e.g., URL, address, or the like, of a resource for which a secure optical code is to be generated. For example, the server 106, or a server 104, may host a website for which a secure optical code is to be generated. The URL or network address of the website is input to the secure optical code generator 120, either automatically by a process running on one of the servers 104, 106 or manually by an authorized user via a user interface. For example, a user may create a new portion of content on a website and wish to generate a secure optical code to be used in advertising so that potential customers may utilize the secure optical code to access this new portion of content.

The secure optical code generator 120 operates on the supplied URL or address in accordance with the illustrative embodiments to generate a secure optical code for use in a print or visual output manner. For example, the optical code may be a Quick Response (QR) code, bar code, Microsoft Tag, or the like, which, when scanned by an image capture device, e.g., a camera, and interpreted by a corresponding secure optical code application 130 on a client device, e.g., client device 114, causes the client device 114 to access the corresponding resource, e.g., the webpage hosted by server 104 or 106. The secure optical code, which again for purposes of illustration will be considered to be a QR code, but it should be appreciated that the secure optical code is not limited to QR codes or any particular optical code, may be used, for example, on any printable content including print advertisements, magazines, posters, books, or the like. The secure optical codes may also be used with any electronically generated visual output, such as on a video screen, liquid crystal display (LCD), television display, or the like. Essentially, any utilization of the secure optical codes in a manner by which the secure optical code may be scanned or an image of the secure optical code may be captured by an image capture device is envisioned.

Given the reference to the content, which for purposes of illustration will be considered to be a URL but again it should be appreciated that any reference may be utilized including other forms of network addresses and the like, the secure optical code generator 120 employs a security application 122 or module to generate a signature for the URL to thereby sign the URL. For example, in one illustrative embodiment, the secure optical code generator 120 and security application 122 are associated with a domain of the website hosted by the server 106. In such an embodiment, a signature capability tied to the domain, such as a private Secure Socket Layer (SSL) certificate, a hash value of the URL generated using public-private key encryption, or other currently known or later developed security signature mechanism, is utilized by the security application 122 associated with the domain so as to generate the signature for the URL. The signature of the URL is combined with the URL to generate a signed URL. In one illustrative embodiment, the signature of the URL is added to the URL as a query parameter, however any other methodology for adding the signature to the URL may be utilized without departing from the spirit and scope of the illustrative embodiments.

The resulting signed URL is then used by the secure optical code generator 120 as a basis for generating an optical code, e.g., QR code, such that the signed URL, including the generated signature, is encoded by the QR code output by the secure optical code generator 120. Thus, the QR code includes information for verifying the integrity of the QR code. That is, when decoded, if the embedded signature does not match with the URL signed by the signature, then the integrity of the QR code will be determined to have been violated.

The QR code generated by the secure optical code generator 120 may be applied to print material or output via a visual output device, such as a LCD or the like. At a later time, a client device, such as client 114, may utilize its associated image capture device to capture an image of the QR code. The captured image of the QR code is processed by the client computing device's secure optical code application 130, which may interface with the image capture device to initiate the image capture. In processing the QR code, the secure optical code application 130 extracts the URL and the signature from the QR code and utilizes the URL to send a request to the domain associated with the resource via the network 102 and server 106, which hosts the domain, requesting the public key or other public decryption information for the domain.

The server 106 responds to the client computing device's request with the corresponding public key or public decryption information (hereafter assumed to be a public key for purposes of illustration) which is received by the client device 114. The public key is then used to decrypt the signature of the URL extracted from the secure QR code. The decrypted signature is compared to the URL extracted from the secure QR code to determine if there is a match or a mismatch. If there is a match between the signature and the URL, then the integrity of the URL is verified. If there is not a match, then a warning message may be output on the client device 114, accessing of the resource associated with the URL may be blocked, or other appropriate action may be taken to warn the user of the potential risk of accessing the resource associated with the URL. In one illustrative embodiment, a warning message may be output on the client device 114 informing the user of the risk via a graphical user interface and having options to continue with the access operation of abort the access operation. If the user chooses to continue the access operation, the URL may be used to access the corresponding resource. If the user chooses to abort the access operation, the access operation is discontinued without accessing the resource.

If the URL's integrity is verified, or if the user chooses to continue on with the access operation after having been warned of the violation of the URL's integrity, before accessing the resource corresponding to the URL, the client device 114 may send a request for authentication of the source of the resource to a reputation database application 140 hosted by an authentication service on a trusted server 104, for example. The reputation database application 140 receives an identifier of the domain that is potentially being accessed and performs a lookup operation in the reputation database 142 to determine if the domain has previously been investigated and determined to be reputable or not reputable. The reputation database 142 may store source information or domain identifiers that have been found to be reputable by the reputation database application 140 or, in an alternative implementation, found to be not reputable by the reputation database 140. In still a further implementation, both a database of reputable sources/domains and a database of disreputable sources/domains may be utilized and a lookup in both may be performed. If the source or domain is determined to be reputable or disreputable based on the lookup operation, the server 104 sends an appropriate response message back to the client device 114. If the source or domain is not found in the reputation database 142, a corresponding response message indicating that the source or domain could not be verified is returned.

Depending upon the results of the source/domain reputation verification, the client device 114 outputs a corresponding message to the user and/or continues on with the access operation for accessing the resource associated with the URL extracted from the secure QR code. For example, if the response message from the server 104 indicates that the source/domain is reputable, then the access operation may continue unimpeded and without contacting the user, or provides the user with a visual indicator, such as a green checkmark for example, indicating that the URL has been validated. If the response message from the server 104 indicates that the source/domain is disreputable or could not be verified, a corresponding message may be output to the user via the client device 114 indicating the corresponding level of risk. For example, for a disreputable source/domain a message of “There is a high level of risk that continuing the access operation may result in corruption of your device. Do you want to continue?” may be output along with options for the user to continue on with the access operation or abort the operation. Alternatively, a message of “The access operation has been blocked in order to prevent corruption of your device” without any options for the user to continue the operation. For a source/domain that could not be verified, a different message may be output of the nature “The resource you are attempting to access could not be verified. There is a potential risk of corruption if you continue your access operation. Do you want to continue?” along with corresponding operations for the user to continue or abort the access operation.

As mentioned above, in some illustrative embodiments, in addition to, or in replacement of, the digital signature generated by the security application 122 associated with the domain, the secure optical code generator 120 may encode in the QR code physical attributes of the object to which the QR code is affixed. This is especially useful in commercial or shipping applications where the QR code is affixed to a product or package that is either sold or shipped via a wholesale or retailer establishment or package shipping/delivery service. However, it should be appreciated that such an illustrative embodiment may be used in other applications depending on the desired implementation.

Similar to the digital signature generated by the security application 122, these physical characteristics of the object may also be added to the URL. For example, in one illustrative embodiment, these physical characteristics may be added to the URL as query parameters, e.g., the dimensions of the product/package including weight, height, width, depth, and the like, may be added as parameters to the URL. Other characteristics of the product/package may also be utilized with the URL as well including color, serial number of the product, unique identifier of the product (such as an International Standard Book Number (ISBN) of the product), name of the product, unique shipping tracking number of the package, or the like. These physical characteristics and unique product/package identifiers may be added to the URL prior to generating a signature for the URL such that the signature captures the combination of the URL and the physical characteristics/unique product/package identifiers. Thus, the signature may be used to verify both the URL and the physical characteristics/unique identifiers of the product/package. Alternatively, the signature may still be generated for just the URL portion while the physical characteristics/unique identifiers remain unsigned such that they may be verified quickly.

When the secure QR code having the physical characteristics and digital signature encoded in it is scanned by an image capture device, such as an image capture device of computing device 110, and a corresponding secure optical code application 150 is utilized to interpret the secure QR code, the URL is again used to access the domain of the server 106 to obtain the public key or other public decryption information for decrypting the signature extracted from the secure QR code. The signature is then used to verify against both the URL and the physical characteristics/unique identifiers, or alternatively just the URL in the manner described above. The physical characteristics/unique identifiers of the object (product or package, for example) to which the secure QR code is affixed may further be validated by measuring the actual physical characteristics by a physical characteristic measurement system 160 and comparing them to those that are specified in the secure QR code.

If these characteristics match within a given tolerance, then the secure QR code is authenticated at least with regard to the physical characteristics, i.e. the secure QR code is still affixed to the object that it was intended to represent. If these characteristics do not match within the given tolerance, where the tolerance is used to accommodate acceptable differences is measuring equipment 160, for example, if the signature does not match the URL or physical characteristics, or if the domain or source designation is determined to be not reputable as discussed above, then the accessing of the content associated with the secure QR code may be disabled or blocked, or an appropriate warning message may be output to the user. It should be appreciated that the physical characteristic measurement system 160 may also utilize other types of measurement apparatus for identifying unique identifiers of the object including optical character reading to read characters printed on the object that may be indicative of a unique identifier of the object, e.g., a tracking number on another shipping label affixed to the package, text describing the contents of the package, or the like.

If any of the URL, source, or the physical characteristics/unique identifiers of the secure QR code are not authenticated by the secure optical code application 150, then an appropriate warning message may be output via the client device 110. Moreover, operations may be performed to interrupt the shipping, sale, or delivery of the object, or other appropriate operation. For example, in the case of shipping/delivery, the object (package) may be routed or otherwise placed in a holding area for physical inspection by a human to determine an appropriate action to correct the error detected by the failure to authentic the secure QR code. In the case of a sales situation, an appropriate message may be output on the client device 110 instructing the user or operator to contact a manager or other authorized individual that is able to perform actions to rectify the situation by physically inspecting the object that is the basis of the sale.

In one illustrative embodiment, the client computer 110 may be a computer in a distribution center of a package shipping/delivery business. As packages pass by a location within the distribution center, their secure QR codes may be scanned by the client computer 110 and the secure QR codes may be interpreted in accordance with the illustrative embodiments using the secure optical code application 150. At a substantially same time, the physical characteristics of the package may be measured by the physical characteristics measurement system 160 as the package is passed by the location. Thus, at substantially a same time both the source/domain information for the QR code is verified and the physical characteristics of the package are verified to ensure that the secure QR code's integrity is maintained, that the secure QR code was generated by a reputable source, and that the secure QR code is affixed to the object that it actually represents.

Thus, the illustrative embodiments provide mechanisms for verifying the integrity of the optical code, verifying the correctness of the association of the optical code with a physical object, and verifying the reputation of the domain or source associated with the optical code. As a result, the mechanisms of the illustrative embodiments minimize the likelihood that a malicious entity is able to tamper with or replace a valid optical code with a malicious one. In addition, the mechanisms of the illustrative embodiments provide for the detection of misplaced optical codes.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

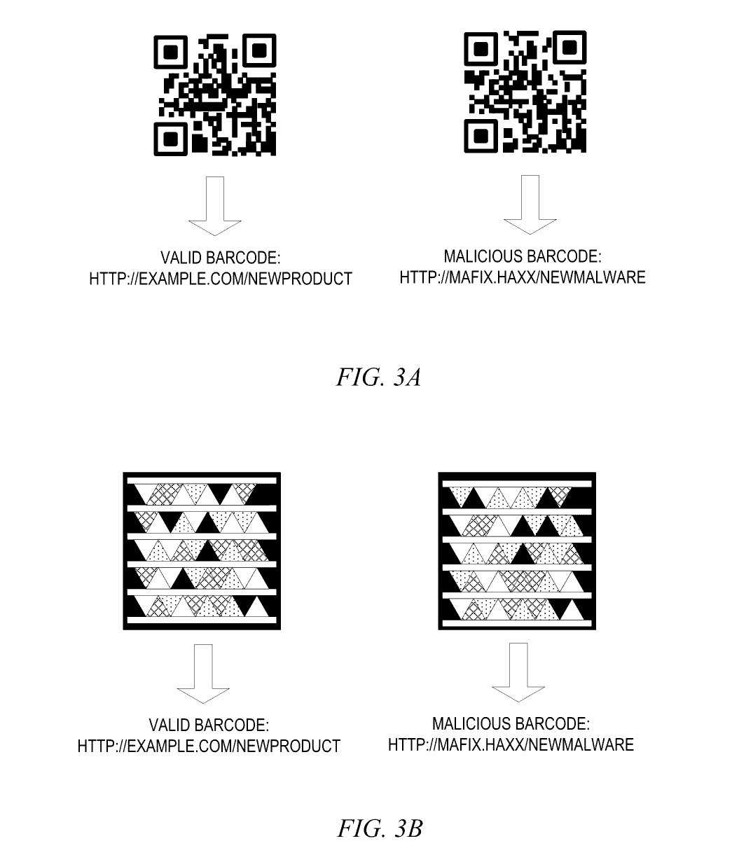

As mentioned above, the problem addressed by the illustrative embodiments is based in the fact that optical codes are not readily able to be interpreted by human beings upon visual inspection. That is, a human being cannot discern the difference between a valid optical code and a malicious optical code. This is illustrated in FIGS. 3A and 3B where examples of valid and malicious optical codes are provided. FIG. 3A illustrates a valid and a malicious optical code which are in the form of QR codes. FIG. 3B illustrates a valid and a malicious optical code which are in the form of a Microsoft Tag. As can be seen from these diagrams, a human being, not knowing a priori that the malicious optical code is malicious in nature, is not able to determine that the valid optical code is valid and the malicious optical code is malicious in nature. To the contrary, the human being merely sees a pattern of shapes of varying shades but does not know what these represent. Thus, this inability to differentiate valid from malicious codes leads to a potential exploitation by malicious individuals.

This is rectified by the secure optical codes generated using the mechanisms of the illustrative embodiments as noted above. That is, through the generation of secure optical codes in which the reference to a resource, and optionally the physical characteristics/unique identifiers of the objects to which the secure optical code is to be affixed, are signed by a security mechanism prior to generation of the optical code, the integrity of the reference, the reputation of the source, and the correctness of the association of the secure optical code with a particular object may be verified, thereby avoiding the ability for malicious individuals to tamper with or replace optical codes with malicious ones.

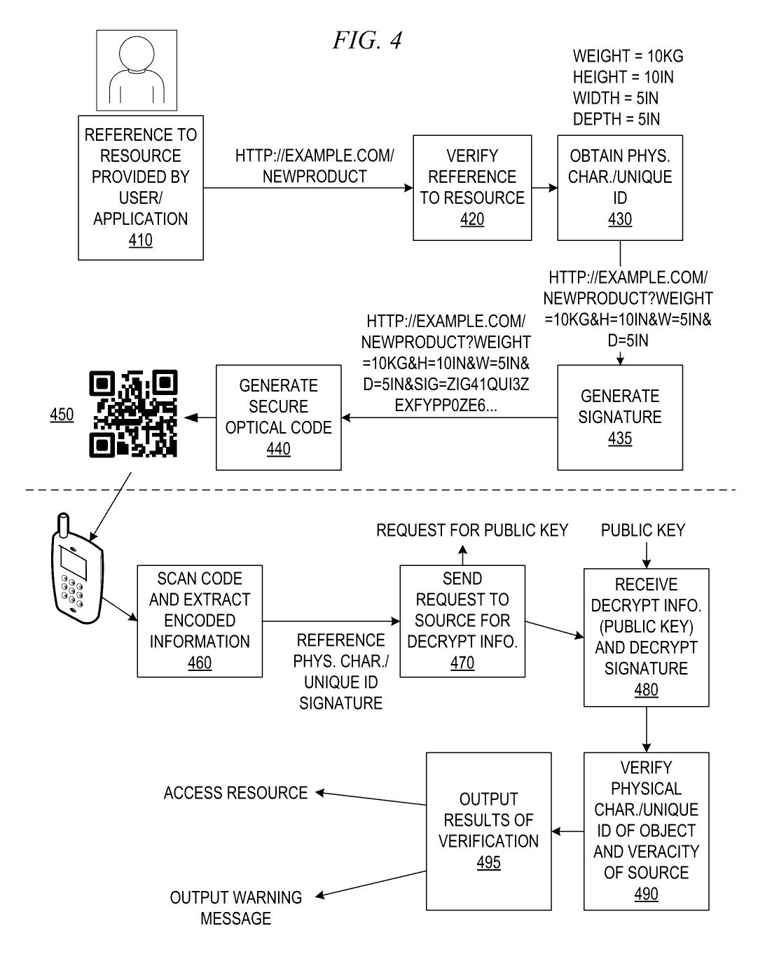

FIG. 4 is a diagram illustrating various stages of secure optical code generation and utilization in accordance with one illustrative embodiment. As shown in FIG. 4, in a first stage of operation 410, a user or application provides a reference (e.g., URL) for a resource, for which a secure optical code is to be generated, to the secure optical code generator. The secure optical code generator may then, in stage 420, verify the reference, e.g., the domain of the reference, such as by accessing a reputation database to ensure that the source or domain is associated with a reputable provider, ensuring that the reference actually accesses a target resource, and the like. The secure optical code generator may further receive, in stage 430, the physical characteristics/unique identifiers associated with the resource. This may be accomplished through a measurement system associated with the secure optical code generator, through input by a user, or the like. The secure optical code generator then generates the signature for the reference, and optionally the physical characteristics/unique identifiers (stage 435), and generates a secure optical code (stage 440) and outputs the secure optical code for use with the resource (stage 450). This output may include, for example, printing a shipping label, printing an advertisement, generating a visual output of the secure optical code, or the like.

At a later time, in stage 460, the secure optical code is scanned by a client device and the reference, physical characteristics/unique identifiers, and signature are extracted. If the optical code scanner is not built to recognize a signature URL parameter, the scanner simply processes the optical code normally and the signature will be effectively ignored without compromising functionality of the optical code. In stage 470, a request is sent to a source of the resource, e.g., a host of a domain associated with the reference (e.g., URL) in the secure optical code, requesting decryption information, e.g., public key. In stage 480 the decryption information is received and the signature in the secure optical code is decrypted and used to verify the reference in the secure optical code. In addition, the physical characteristics/unique identifiers in the secure optical code are verified as well. In stage 490, the veracity of the source/domain is verified, such as by accessing a reputation service to verify the reputation of the source/domain. In stage 495, a result of the verifications is generated and corresponding access and/or output messages are generated.

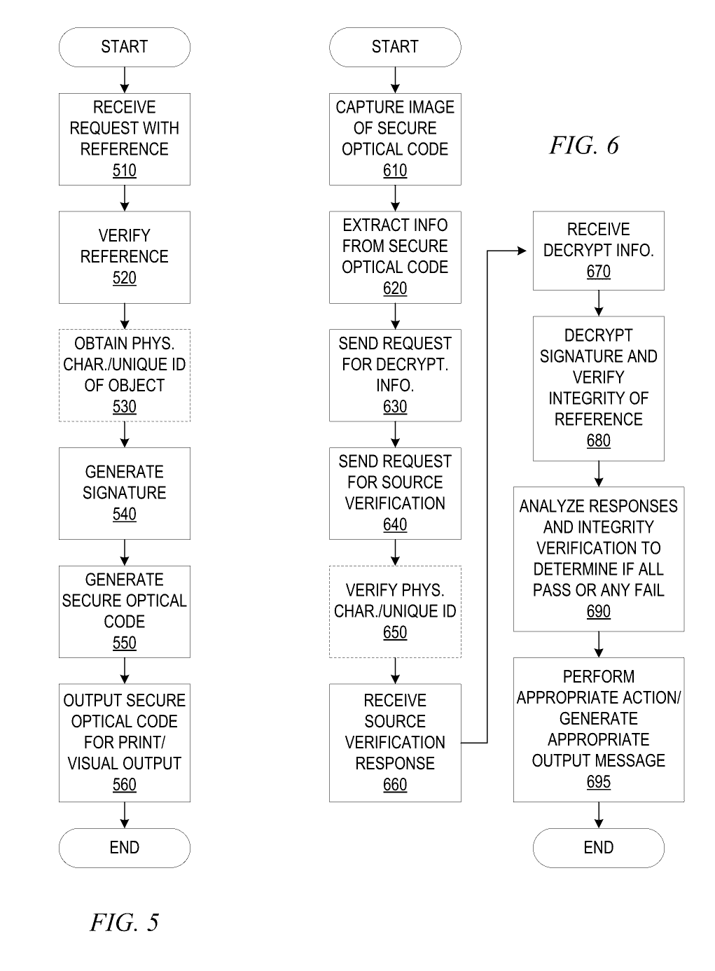

FIG. 5 is a flowchart outlining an example operation for generating a secure optical code in accordance with one illustrative embodiment. The operation outlined in FIG. 5 may be implemented by a secure optical code generator, such as secure optical code generate 120 in FIG. 1, for example, which may utilize an integrated or separate security application and reputation database application. The secure optical code generator may be implemented as software instructions executing on hardware of a data processing system, specialized hardware devices of a data processing system, such as application specific integrated circuit (ASIC) devices, firmware, or the like, or any combination of specialized hardware devices and software executing on general hardware of a data processing system.

As shown in FIG. 5, the operation starts with receiving a request to generate a secure optical code, where the request includes an identification of the reference to a resource for which the secure optical code is to be generated (step 510). The reference to the resource is verified (step 520) and then optionally (the optional nature being represented by the dashed box) physical characteristics/unique identifiers associated with the resource are obtained (step 530). A signature for the reference and optional physical characteristics/unique identifiers is generated (step 540). The combination of the reference, physical characteristics/unique identifiers, and signature are used as a basis for generating a secure optical code (step 550). The secure optical code is then output for use, such as by printing labels or other printable materials, output via electronic mechanisms, or the like (step 560).

FIG. 6 is a flowchart outlining an example operation for processing a secure optical code in accordance with one illustrative embodiment. The operations outlined in FIG. 6 may be performed, for example, by a secure optical code application of a client device, such as secure optical code application 150 in FIG. 1. The secure optical code application may also utilize an integrated or separate a physical characteristics/unique identifier measurement/identification system, such as physical characteristics measurement system 160 in FIG. 1, for example. The secure optical code application may be implemented as software instructions executing on hardware of a data processing system, specialized hardware devices of a data processing system, such as application specific integrated circuit (ASIC) devices, firmware, or the like, or any combination of specialized hardware devices and software executing on general hardware of a data processing system.

As shown in FIG. 6, the operation starts with a client device scanning or otherwise capturing an image of the secure optical code (step 610). The reference, physical characteristics/unique identifiers (if any), and signature are extracted from the secure optical code (step 620). A request is sent to a source of the reference, e.g., a server hosting the domain of the reference, to request the public decryption information, e.g., public key, associated with the reference (step 630). In addition, a request is sent to a source verification service, such as a reputation service, to verify the source as a reputable source (step 640). Optionally, if the secure optical code includes physical characteristics/unique identifiers, then these may be verified using an integrated or separate measurement/identifier system (step 650).

A response is received from the source verification service indicating whether or not the source could be verified as reputable (step 660) and the public decryption information is received from the source (step 670). The signature is decrypted using the decryption information and the decrypted signature is used to verify the integrity of the reference (step 680). The response from the source verification service, the result of the verification of the physical characteristics/unique identifiers, and the result of the verification of the integrity of the reference are analyzed to determine if these verifications have been passed or if any have failed (step 690). A corresponding action and message output is performed by the client device in response to the verifications either all passing or one or more of the verifications failing (step 695). The operation then terminates.

Thus, the illustrative embodiments provide mechanisms to prevent or at least minimize a user's exposure to malicious content when making use of an optical code to access content and/or identify accidental misplacement of optical codes. The illustrative embodiments provide mechanisms for authenticating the optical code as well as the source of the content to which the optical code directs the user's client device. Appropriate warnings may be output to the user in response to these authentications failing. Moreover, in some cases, access to potentially malicious content may be blocked entirely to prevent corruption of the client device.

It should be noted that while the above illustrative embodiments describe the output of a warning in response to any of the integrity of the reference to content (e.g., URL), the physical characteristics or unique identifiers of the object, or the reputation of the domain/source of the content not being able to be positively verified, in some illustrative embodiments, a single, or multiple, warnings may be output to a user with the particular basis for the warning being specified, e.g., which verification checks failed. The warning message(s) may include a user option to continue on with the access of the content despite the warning and/or a user option to abort the access of the content. In this way, the user is informed of the particular verification checks that failed so that the user can weigh the risks, e.g., even though the domain is not able to be verified as safe, the user may still want to access the content since the reference's integrity was determined to be verified and the physical characteristics were verified, or even though the physical characteristics were not verified, the integrity of the reference is verified and the source is reputable so the user may wish to continue on with the access operation.

It should also be noted that other actions may be performed other than generating and outputting a warning message or blocking the access operation without departing from the spirit and scope of the illustrative embodiments. For example, other types of messages other than warning messages may be output, e.g., initiating a search for a correct reference to the content in response to the integrity of the reference being violated, such as by way of looking up certificate information in a certificate issuing authority's data processing system. Issuing a request to the user to verify the content that the user is attempting to access, e.g., “are you trying to access the website maliciousme.com?” Other actions may be to report the verification failures to an enforcement authority by sending an appropriate electronic communication specifying the reference, the certificate used to sign the reference, and an indication of the verification failures that occurred. In some cases, no action may be performed. Any action that is appropriate under the circumstances is intended to be within the spirit and scope of the illustrative embodiments.

In still a further illustrative embodiment, the data processing system or originator of the optical codes may store a copy of the optical codes in association with a private/public key, certificate, or other security information used to generate the optical code in a history data structure associated with the data processing system or originator. In such an illustrative embodiment, different security information may be used with each optical code in order to provide further security of the optical codes. When a client device requests the public decryption information for a scanned optical code, the request may include an identifier of the optical code so as to facilitate a lookup of the corresponding security information for that particular optical code in the data processing system or originator of the optical code and have the corresponding public security information returned to the client device for use in decrypting the signature.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, for generating a secure optical code having a reference to a resource encoded therein, the method comprising:
receiving, by the data processing system, the reference to the resource for which a secure optical code is to be generated;
generating, by the data processing system, a digital signature for the reference;
modifying, by the data processing system, the reference to the resource to include the digital signature and thereby generate a modified reference;
generating, by the data processing system, a secure optical code based on the modified reference, wherein the secure optical code encodes both the reference to the resource and the digital signature; and
outputting, by the data processing system, the secure optical code for implementation in a print or visual output, wherein the secure optical code is a pattern of shapes, having at least one of different positions or visual characteristics, which together represent the modified reference.

2. The method of claim 1, wherein the secure optical code is one of a Quick Response (QR) code or a two-dimensional bar code.

3. The method of claim 1, wherein the reference is a Uniform Resource Locator (URL) and wherein modifying the reference to the resource to include the digital signature comprises appending the digital signature to the URL as a query parameter.

4. The method of claim 1, further comprising:
obtaining, by the data processing system, object information identifying at least one of a physical characteristic or a unique identifier of an object with which the secure optical code is to be associated; and
combining, by the data processing system, the object information with the reference prior to generating the digital signature for the reference, wherein generating the digital signature for the reference comprises generating the digital signature based on a combination of the reference and the object information, and wherein the modified reference comprises a combination of the reference, the object information, and the signature.

5. The method of claim 4, wherein combining the object information with the reference prior to generating the digital signature for the reference comprises appending the object information to the reference as one or more query parameters.

6. The method of claim 4, wherein the object information comprises at least one physical dimension of the object.

7. The method of claim 1, wherein generating a digital signature for the reference comprises using private encryption information for a source of the resource to generate the digital signature, and wherein the digital signature is decrypted using public decryption information associated with the source of the resource.

8. The method of claim 1, wherein receiving the reference to the resource for which a secure optical code is to be generated comprises a user navigating to the resource via an application and submitting a request to generate a secure optical code for the resource based on the current location of the resource as specified by the application.

9. The method of claim 1, wherein the data processing system is a data processing system that provides the resource for access by users via one or more data networks, such that the method is implemented by the data processing system that provides the resource.

10. The method of claim 1, wherein the resource is one of a Internet web page or multi-media content available via a data network, and wherein the reference is a Uniform Resource Locator (URL) or network address of the Internet web page or multi-media content.

11. A computer program product comprising a computer readable storage medium having a computer readable program stored therein, wherein the computer readable program, when executed on a computing device, causes the computing device to:
receive a reference to a resource for which a secure optical code is to be generated;
generate a digital signature for the reference;
modify the reference to the resource to include the digital signature and thereby generate a modified reference;
generate a secure optical code based on the modified reference, wherein the secure optical code encodes both the reference to the resource and the digital signature; and
output the secure optical code for implementation in a print or visual output, wherein the secure optical code is a pattern of shapes, having at least one of different positions or visual characteristics, which together represent the modified reference.

12. The computer program product of claim 11, wherein the secure optical code is one of a Quick Response (QR) code or a two-dimensional bar code.

13. The computer program product of claim 11, wherein the reference is a Uniform Resource Locator (URL) and wherein modifying the reference to the resource to include the digital signature comprises appending the digital signature to the URL as a query parameter.

14. The computer program product of claim 11, wherein the computer readable program further causes the computing device to:
obtain object information identifying at least one of a physical characteristic or a unique identifier of an object with which the secure optical code is to be associated; and
combine the object information with the reference prior to generating the digital signature for the reference, wherein the computer readable program further causes the computing device to generate the digital signature for the reference at least by generating the digital signature based on a combination of the reference and the object information, and wherein the modified reference comprises a combination of the reference, the object information, and the signature.

15. The computer program product of claim 14, wherein the computer readable program further causes the computing device to combine the object information with the reference prior to generating the digital signature for the reference at least by appending the object information to the reference as one or more query parameters.

16. The computer program product of claim 14, wherein the object information comprises at least one physical dimension of the object.

17. The computer program product of claim 11, wherein the computer readable program further causes the computing device to generate a digital signature for the reference at least by using private encryption information for a source of the resource to generate the digital signature, and wherein the digital signature is decrypted using public decryption information associated with the source of the resource.

18. The computer program product of claim 11, wherein the computer readable program further causes the computing device to receive the reference to the resource for which a secure optical code is to be generated at least by a user navigating to the resource via an application and submitting a request to generate a secure optical code for the resource based on the current location of the resource as specified by the application.

19. The computer program product of claim 11, wherein the resource is one of a Internet web page or multi-media content available via a data network, and wherein the reference is a Uniform Resource Locator (URL) or network address of the Internet web page or multi-media content.

20. An apparatus comprising:
a processor; and
a memory coupled to the processor, wherein the memory comprises instructions which, when executed by the processor, cause the processor to:
receive a reference to a resource for which a secure optical code is to be generated;
generate a digital signature for the reference;
modify the reference to the resource to include the digital signature and thereby generate a modified reference;
generate a secure optical code based on the modified reference, wherein the secure optical code encodes both the reference to the resource and the digital signature; and
output the secure optical code for implementation in a print or visual output, wherein the secure optical code is a pattern of shapes, having at least one of different positions or visual characteristics, which together represent the modified reference.
